(19) United States
(12) Patent Application Publication
(10) Pub. No.: US 2008/0270931 A1
(43) Pub. Date: Oct. 30, 2008

(54) Touch-based tab navigation method and related device

(76) Inventor: Drew Bamford, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 12/037,942

(22) Filed: Feb. 27, 2008

Related U.S. Application Data
(60) Provisional application No. 60/915,440, filed on May 2, 2007.
(60) Provisional application No. 60/914,323, filed on Apr. 27, 2007.

(51) Int. Cl. G06F 3/048

(52) U.S. Cl. 715/777

(57) ABSTRACT

A method of navigating between different tabs in a user interface of a portable digital information device includes displaying a first set of tabs sequentially arranged along a linear direction on a display of the portable digital information device, the first set of tabs containing tabs that are a subset of tabs contained in a master set of tabs. A user then touches a touch-sensitive area of the portable digital information device and drags a finger across the touch-sensitive area in a direction parallel to the linear direction in which the first set of tabs are sequentially arranged. This dragging motion causes the position of the tabs displayed along the linear direction of the display to move in a direction opposite to the direction along which the user drags the finger across the touch-sensitive area for displaying a second set of tabs containing tabs.

### CROSS REFERENCE TO RELATED APPLICATIONS

This application claims the benefit of the filing date of U.S. provisional patent application No. 60/914,323, filed Apr. 27, 2007, and U.S. provisional patent application No. 60/915,440, filed May 2, 2007, the contents of which are hereby incorporated by reference.

### BACKGROUND OF THE INVENTION

1. Field of the Invention

The invention relates to a navigation method for a portable electronic device, and more particularly, to a touch-based tab navigation method for a portable electronic device.

2. Description of the Prior Art

As the market for portable electronic devices develops, the number of functions that the portable electronic devices are capable of performing increases greatly. Along with a larger number of functions comes a need to navigate through a user interface of the portable electronic devices in order to access these functions. Graphical user interfaces are now commonly used due to their advantages of being clear and intuitive.

Please refer to FIG. 1. FIG. 1 is a diagram 5 showing three different tab-based navigation systems according to the prior art. Screen 10 shows a ½ cut tab providing a choice of tab 12 and tab 14. Screen 20 shows a ⅓ cut tab providing a choice of tab 22, tab 24, and tab 26. Screen 30 shows a ⅕ cut tab providing a choice of tab 32, tab 34, tab 36, tab 38, and tab 40. The tab-based navigation system makes it easy for users to not only see which tab is open, but to also see other available tabs that are not being viewed.

Please refer to FIG. 2. FIG. 2 is a screen 50 showing another tab-based navigation system according to the prior art. Screen 50 shows tabs 52, 54, 56, 58, 60, 62, and 64. Tab 62 is currently open, whereas the other tabs 52, 54, 56, 58, 60, and 64 are not being viewed. A menu 66 corresponding to tab 62 is shown, and provides options for the user corresponding to tab 62.

Please refer to FIG. 3. FIG. 3 illustrates three text boxes 70, 80, and 90 according to the prior art. Text box 70 has been designed to have a fixed width and a fixed height, and does not have any scroll bars. Text box 80 has a fixed width and a variable height, and therefore has a scroll bar 82 containing directional arrow icons 84 and 86 for scrolling up and down. Text box 90 has a variable width and a variable height, and therefore has a scroll bar 91 containing directional arrow icons 92 and 93 for scrolling up and down, as well as a scroll bar 95 containing directional arrow icons 96 and 97 for scrolling left and right.

Although the prior art navigation systems shown in FIGS. 1-3 are functional, the navigation systems can be cumbersome to use, and are not always convenient for users using small touch-sensitive displays such as those found on a personal digital assistant (PDA) or a smart phone. Instead, there is a need for a simple and intuitive touch-based navigation system that lets users of small touch-sensitive input devices quickly navigate through the user interface.

### SUMMARY OF THE INVENTION

It is therefore one of the primary objectives of the claimed invention to provide a touch-based tab navigation method and related device for allowing users to navigate through menu options using a touch-sensitive input device.

According to an exemplary embodiment of the claimed invention, a method of navigating between different tabs in a user interface of a portable digital information device is disclosed. The method includes displaying a first set of tabs sequentially arranged along a linear direction on a display of the portable digital information device, the first set of tabs containing tabs that are a subset of tabs contained in a master set of tabs. Touch input is then received from a user in which the user touches a touch-sensitive area of the portable digital information device and drags a finger across the touch-sensitive area in a direction parallel to the linear direction in which the first set of tabs are sequentially arranged. Next, the position of the tabs displayed along the linear direction of the display are changed in response to receiving the touch input from the user, the position of the tabs moving in a direction opposite to the direction along which the user drags the finger across the touch-sensitive area. Then a second set of tabs containing tabs that are a subset of tabs contained in the master set of tabs is displayed in response to the change in position of the tabs.

According to another exemplary embodiment of the claimed invention, a portable digital information device adapted for receiving touch input from a user for navigating between different tabs in a user interface of the portable digital information device is disclosed. The portable digital information device includes a display for displaying a first set of tabs sequentially arranged along a linear direction, the first set of tabs containing tabs that are a subset of tabs contained in a master set of tabs. A touch-sensitive area is provided for receiving touch input from a user in which the user touches the touch-sensitive area and drags a finger across the touch-sensitive area in a direction parallel to the linear direction in which the first set of tabs are sequentially arranged. The portable digital information device also includes a processor for receiving the touch input and changing a position of tabs displayed along the linear direction of the display in response to receiving the touch input from the user, the processor moving the position of the tabs in a direction opposite to the direction along which the user drags the finger across the touch-sensitive area, the processor controlling the display to display a second set of tabs containing tabs that are a subset of tabs contained in the master set of tabs in response to the change in position of the tabs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing three different tab-based navigation systems according to the prior art.

FIG. 2 is a screen showing another tab-based navigation system according to the prior art.

FIG. 3 illustrates three text boxes according to the prior art.

FIG. 4 is a functional block diagram of a portable digital information device according to the present invention.

FIG. 5 is a top view of an embodiment of the portable digital information device according to the present invention.

FIGS. 6-8, which show the contents of the display of the portable digital information device when different tabs of the navigation section are chosen as the selected tab.

FIGS. 9 and 10 illustrate a displayed segment and non-displayed segments of the navigation section.

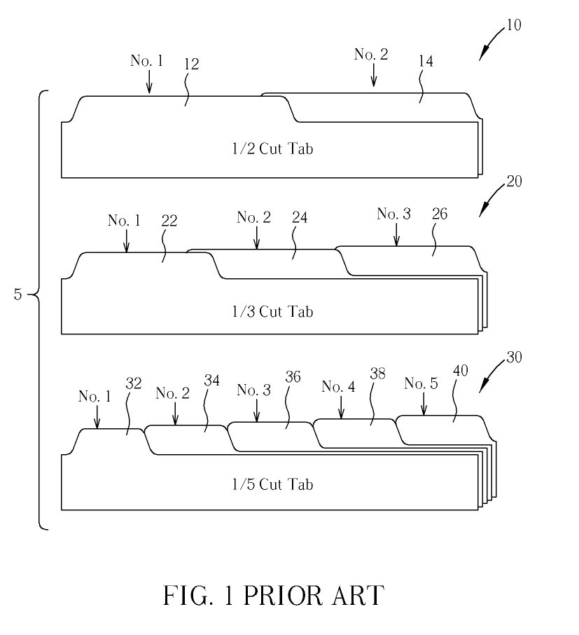

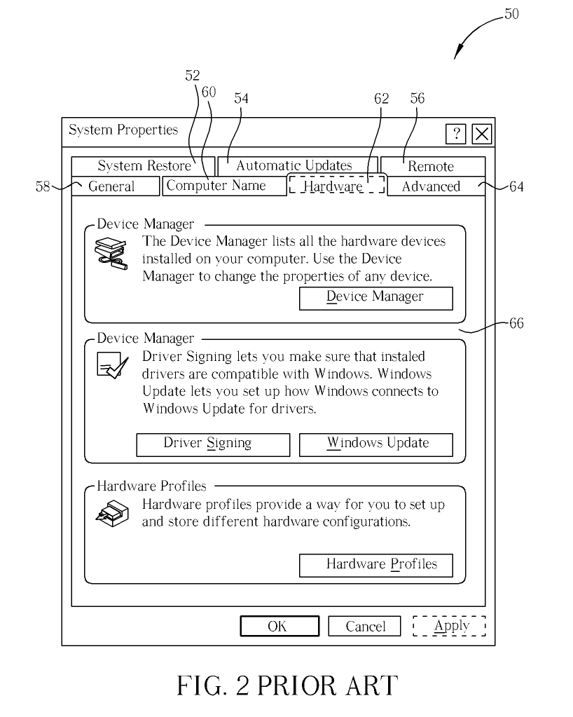

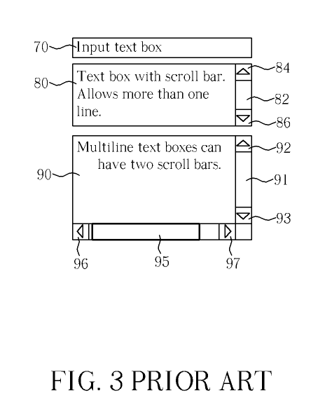

### DETAILED DESCRIPTION

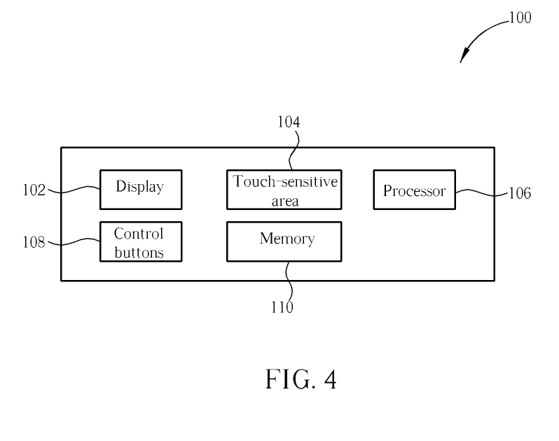

Please refer to FIG. 4. FIG. 4 is a functional block diagram of a portable digital information device 100 according to the present invention. The portable digital information device 100 comprises a display 102, a touch-sensitive area 104, a processor 106, control buttons 108, and a memory 110. The touch-sensitive area 104 may be installed on the portable digital information device 100 separately from the display 102, or can be a part of the display 102, in which case the display 102 is a touch-sensitive display. The touch-sensitive area 104 is adapted for receiving input from a user's finger for controlling operation of the portable digital information device 100, although other input devices such as a stylus may also be used. The processor 106 controls operation of the portable digital information device 100 and controls the graphics shown on the display 102 in response to input received from the touch-sensitive area 104 or the control buttons 108. The memory 110 stores user data and application programs of the portable digital information device 100.

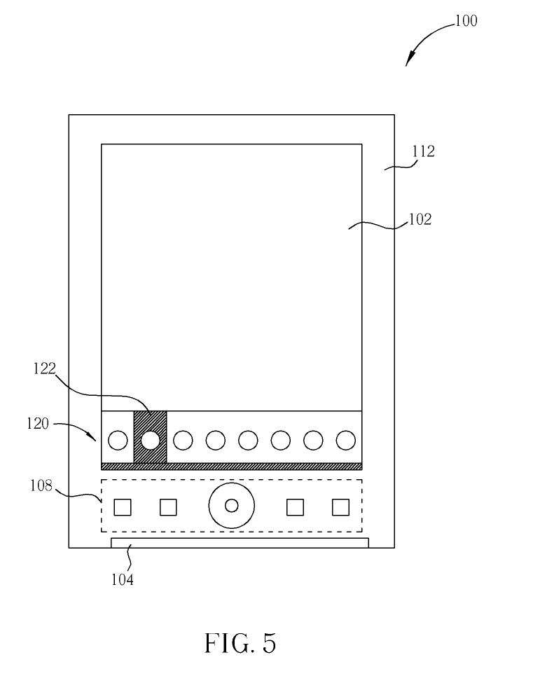

Please refer to FIG. 5. FIG. 5 is a top view of an embodiment of the portable digital information device 100 according to the present invention. The portable digital information device 100 comprises a housing 112 on which the display 102, the touch-sensitive area 104, and the control buttons 108 are installed. One portion of the display 102 shows a navigation section 120 that is used for navigating through menus of the user interface for the portable digital information device 100. The navigation section 120 preferably contains a plurality of tabs that are represented by icons, and a selected tab 122 is highlighted for indicating which menu item the user is currently viewing.

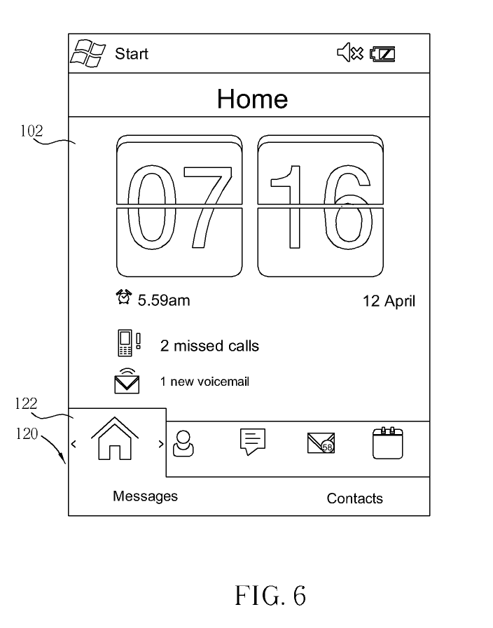

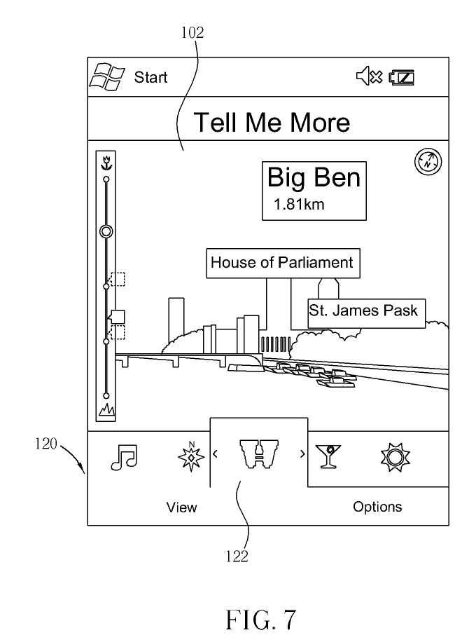

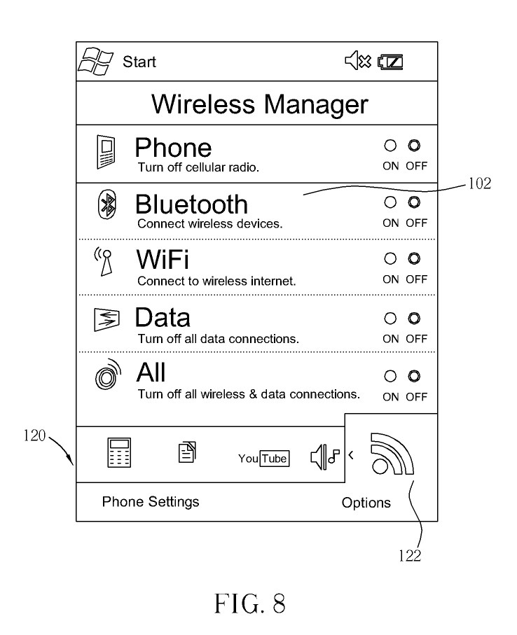

Please refer to FIGS. 6-8, which show the contents of the display 102 when different tabs of the navigation section 120 are chosen as the selected tab 122. Unfortunately, with the increasing amount of functions available in modern devices, not all of the tabs of the navigation section 120 are visible on the display 102 at the same time. Therefore, users must scroll the window in order to see other tabs that are not currently shown on the display 102. For example, using the screen orientation and the tab layout of FIGS. 6-8, a user would have to scroll left and right to see other tabs that are not visible on the screen. The present invention thus provides a novel touch-based navigation system for quickly navigating through the tabs of the navigation section 120.

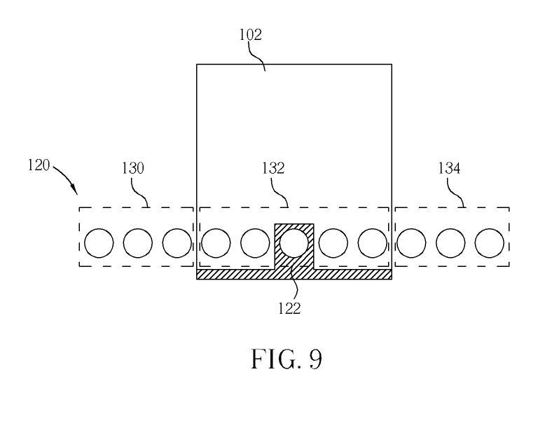

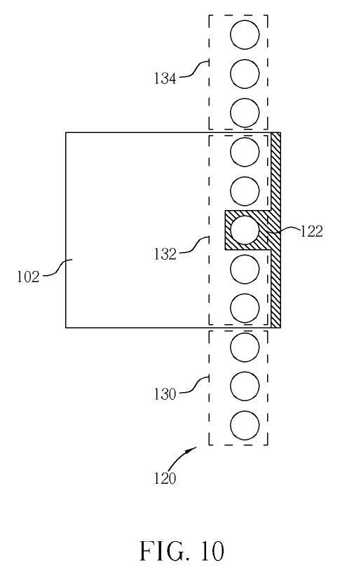

Please refer to FIGS. 9 and 10. FIGS. 9 and 10 illustrate a displayed segment 132 and non-displayed segments 130 and 134 of the navigation section 120. In both of FIGS. 9 and 10, the displayed segment 132 is shown as containing a set of tabs taken from a middle portion of the tabs in the navigation section 120. In FIG. 9, a first non-displayed segment 130 contains tabs that are positioned to the left of the displayed segment 132, whereas a second non-displayed segment 134 contains tabs that are positioned to the right of the displayed segment 132. Similarly, in FIG. 10, the first non-displayed segment 130 contains tabs that are positioned under the displayed segment 132, whereas the second non-displayed segment 134 contains tabs that are positioned on top of the displayed segment 132. Thus, the tabs can be positioned horizontally or vertically and may be displayed on any position of the display 102.

The present invention provides four ways of navigating between tabs of the navigation section 120. First of all, if the display 102 is a touch-sensitive display, the user of the portable digital information device 100 can simply use a finger or a stylus to tap on an icon corresponding to a tab that is currently in the displayed segment 132 of the navigation section 120. Secondly, a directional pad in the control buttons 108 can be used to navigate through the various tabs of the navigation section 120, including the tabs in both the displayed segment 132 and the non-displayed segments 130 and 134 of the navigation section 120.

A third method assumes that the display 102 is a touch-sensitive display. In the third method, the users can drag a tab such as the selected tab 122 through the sequence of icons in the navigation section 120 by swiping their finger across the touch screen until they reach the desired icon. As the user drags the tab, the icons shown in the displayed segment 132 of the navigation section 120 shift in the opposite direction, such that, when the user's finger reaches the end of the display 102, the last icon in the sequence is positioned under their finger. Likewise, when the user's finger is half way across the display 102, the sequence of icons will be positioned such that the middle icon is under their finger. This enables the user to easily navigate a sequence of icons that is wider than the visible extents of the display 102. Additionally, as the user drags the tab through the sequence of icons, the tab snaps to the nearest icon position, for easier targeting of icons.

A fourth method is similar to the third method, but makes use of the touch-sensitive area 104 that is formed separate from the display 102, as shown in FIG. 5. In FIG. 5, the touch-sensitive area 104 is formed at a bottom of the housing of the portable digital information device 100, for allowing a user to swipe his finger across the touch-sensitive area 104 for navigating through the tabs of the navigation section 120. By dragging the user's finger across the touch-sensitive area 104, the tab graphic will be positioned adjacent to the position of the finger. As aforementioned, an amount of position change of the displayed tabs is related to a distance in which the user drags the finger across the touch-sensitive area 104.

In addition to visually seeing the icons corresponding to the tabs move as the user drags his finger across the display 102 or the touch-sensitive area 104, haptic feedback can also be used to provide the user with haptic pulses (vibration pulses) indicating that the icons shown in the displayed segment 132 of the navigation section 120 have shifted by another icon. The use of haptic feedback allows users to better navigate through the tabs of the navigation section 120 without having to look at the display 102 of the portable digital information device 100.

In summary, the present invention provides users with a convenient way of navigating between numerous tabs in a graphical user interface, and allows quick access to tabs that are not currently shown on the display. In addition, user's can rely on muscle memory to choose commonly selected tabs without having to look at the display. This can further be enhanced with haptic feedback or sound feedback for allowing the user to know how many discrete positions the tabs have been moved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of navigating between different tabs in a user interface of a portable digital information device, the method comprising:
displaying a first set of tabs sequentially arranged along a linear direction on a display of the portable digital information device, the first set of tabs containing tabs that are a subset of tabs contained in a master set of tabs;
receiving touch input from a user in which the user touches a touch-sensitive area of the portable digital information device and drags a finger across the touch-sensitive area in a direction parallel to the linear direction in which the first set of tabs are sequentially arranged;
changing a position of tabs displayed along the linear direction of the display in response to receiving the touch input from the user; and
displaying a second set of tabs containing tabs that are a subset of tabs contained in the master set of tabs in response to the change in position of the tabs.

2. The method of claim 1, wherein the touch-sensitive area is a touch-sensitive device formed on a housing of the portable digital information device.

3. The method of claim 2, wherein the touch-sensitive area is separate from the display of the portable digital information device.

4. The method of claim 1, wherein the display of the portable digital information device is a touch-sensitive display, and the touch-sensitive area is a portion of the touch-sensitive display.

5. The method of claim 4, wherein the touch-sensitive area is a portion of the touch-sensitive display at which the tabs are displayed.

6. The method of claim 1, wherein each tab is visually represented by icon.

7. The method of claim 1, wherein an amount of position change of the displayed tabs is related to a distance in which the user drags the finger across the touch-sensitive area.

8. The method of claim 1, wherein tabs of the master set of tabs that are not part of the first set of tabs are displayed on the display after changing the position of tabs displayed on the display.

9. The method of claim 1, further comprising providing haptic feedback to the user in response to every change in position that the tabs make when the user drags the finger across the touch-sensitive area.

10. The method of claim 1, wherein the tabs are arranged horizontally or vertically on the display of the portable digital information device.

11. The method of claim 1, wherein the position of the tabs moving in a direction opposite to the direction along which the user drags the finger across the touch-sensitive area.

12. A portable digital information device adapted for receiving touch input from a user for navigating between different tabs in a user interface of the portable digital information device, the portable digital information device comprising:
a display for displaying a first set of tabs sequentially arranged along a linear direction, the first set of tabs containing tabs that are a subset of tabs contained in a master set of tabs;
a touch-sensitive area for receiving touch input from a user in which the user touches the touch-sensitive area and drags a finger across the touch-sensitive area in a direction parallel to the linear direction in which the first set of tabs are sequentially arranged; and
a processor for receiving the touch input and changing a position of tabs displayed along the linear direction of the display in response to receiving the touch input from the user, the processor moving the position of the tabs, the processor controlling the display to display a second set of tabs containing tabs that are a subset of tabs contained in the master set of tabs in response to the change in position of the tabs.

13. The portable digital information device of claim 12, wherein the touch-sensitive area is a touch-sensitive device formed on a housing of the portable digital information device.

14. The portable digital information device of claim 13, wherein the touch-sensitive area is separate from the display of the portable digital information device.

15. The portable digital information device of claim 12, wherein the display of the portable digital information device is a touch-sensitive display, and the touch-sensitive area is a portion of the touch-sensitive display.

16. The portable digital information device of claim 15, wherein the touch-sensitive area is a portion of the touch-sensitive display at which the tabs are displayed.

17. The portable digital information device of claim 12, wherein each tab is visually represented by icon.

18. The portable digital information device of claim 12, the processor changes position of the displayed tabs in relation to a distance in which the user drags the finger across the touch-sensitive area.

19. The portable digital information device of claim 12, wherein the processor commands the display to display tabs of the master set of tabs that are not part of the first set of tabs after changing the position of tabs displayed on the display.

20. The portable digital information device of claim 12, further comprising a vibrator for providing haptic feedback to the user in response to every change in position that the tabs make when the user drags the finger across the touch-sensitive area.

21. The portable digital information device of claim 12, wherein the tabs are arranged horizontally or vertically on the display of the portable digital information device.

22. The portable digital information device of claim 12, wherein the processor moves the position of the tabs in a direction opposite to the direction along which the user drags the finger across the touch-sensitive area.
